(19) United States
(12) Patent Application Publication
(10) Pub. No.: US 2017/0004420 A1
(43) Pub. Date: Jan. 5, 2017

(54) WORKER VENTURING COEFFICENT FOR WORKFORCE ROUTING

(71) Applicant: ARRIS Enterprises LLC, Suwanee, GA (US)

(72) Inventor: Stuart Thompson, Aloha, OR (US)

(21) Appl. No.: 15/201,850

(22) Filed: Jul. 5, 2016

Related U.S. Application Data
(60) Provisional application No. 62/188,488, filed on Jul. 3, 2015.

(51) Int. Cl. G06Q 10/04; G06Q 10/06; G06F 17/30

(52) U.S. Cl. CPC G06Q 10/047; G06F 17/3053; G06Q 10/063118

(57) ABSTRACT

A method for generating workforce street level routing is provided. The method includes ranking each job within a set of jobs available for assignment at times of day to a worker and producing a street level routing assignment schedule including a sequence of jobs assigned to the worker in which each of the sequence of jobs corresponds to a highest ranked job within the set of jobs available for assignment to the worker at each particular time of day during a work-shift. The ranking step includes creating a coefficient representing an appeal for venturing or homing of the worker at each particular time of day during the work-shift, developing a score from a plurality of factors for each job within the set of jobs at each particular time of day, and using the coefficient representing the appeal for venturing or homing to produce at least one of the factors.

### CROSS REFERENCE TO RELATED APPLICATION

This application claims the benefit under 35 USC §119(e) of U.S. Provisional Patent Application No. 62/188,488, filed Jul. 3, 2015.

### BACKGROUND

Conventionally, a customer wishing to make a service appointment is typically assisted by a booking agent. The booking agent, in some cases, is able to make decisions about availability of field service representatives (FSRs) for scheduling appointments, based, for example, upon estimates of worker capacity and filling daily quotas.

In a typical workforce routing scenario, a pool of FSRs must collectively service a set of jobs distributed over a geographic area. Ordinarily, jobs may only be serviced within certain time windows, technicians have restrictions upon the jobs they can perform, and routes should be determined for each technician such that all jobs are serviced. Routes may be selected based upon a set of criteria that may, for instance, represent a business policy.

Finding an optimal route for field service representatives (FSRs) and jobs is an NP-complete problem (i.e., traveling salesman) that has been computationally impractical to solve through traditional means. Optimal straight-line travel through a region may not be achieved through straight paths due to roads, traffic, and geographic impediments. Determining the optimal route between multiple points at the time of routing extends the execution time of routing algorithms. Street level routing (SLR), due to the significant number of permutations of potential paths, has traditionally been regarded as computationally impractical.

In addition to the above referenced factors, subjective factors may influence a technician's perceived quality of a route.

### BRIEF DESCRIPTION OF THE DRAWINGS

Various features of the embodiments described in the following detailed description can be more fully appreciated when considered with reference to the accompanying figures, wherein the same numbers refer to the same elements.

FIG. 1 is a plot of a venturing/homing amplification factor over the course of a shift of a worker in accordance to an embodiment.

FIG. 2 is a map showing distances between job locations in accordance to an embodiment.

FIG. 3 is a plot of a venturing/homing amplification factor over the course of a shift of a worker for the job locations shown in FIG. 2 in accordance to an embodiment.

FIG. 4 is a map showing estimated driving time between job locations in accordance to an embodiment.

FIG. 5 is a plot of a venturing/homing amplification factor over the course of a shift of a worker that spans two periods of rush hour traffic in accordance to an embodiment.

FIG. 6 is a plot of a venturing/homing amplification factor over the course of a shift of a worker that spans a single period of rush hour traffic in accordance to an embodiment.

FIG. 7 is a map showing estimated driving time between job locations in accordance to an embodiment.

FIG. 8 is example of pseudo-code for an iterative route creation process in accordance to an embodiment.

FIG. 9 is a diagram showing an example of a series of jobs to be scheduled between a pair of workers in accordance to an embodiment.

FIG. 10 is a diagram showing the series of jobs to be scheduled between a pair of workers as shown in FIG. 9 with scheduling times listed for each job in accordance to an embodiment.

FIG. 11 is a plot of a venturing/homing amplification factor over the course of a shift of the workers in the example shown in FIGS. 9 and 10 in accordance to an embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

A workforce routing algorithm encoded within computer-implemented software products and like automated systems used by workforce dispatchers may build a sequence of routes for workers indicating an order in which each of the workers should proceed to service a series of jobs. Such algorithms may match particular workers with particular jobs, and the jobs may be ordered based on a series of business objectives and constraints. By describing business processes through these mechanisms, the routes generated may attempt to match more ideal workers with the type of jobs they are best adapted to service, while remaining within the operational limits of those businesses.

A traveling field worker's impression of their experience with such street level routing and the software, methods, and systems that generate such workforce routing has an influence on the perceived quality of the street level routing algorithm, software, and system. Within workforce management, the perceived quality of the routes a field worker is assigned may strongly affect worker satisfaction as well as impressions of the quality of the software. Accordingly, embodiments of workforce routing described herein distill or use factors (e.g., psychological or subjective factors) that are likely to influence a worker's perception of route quality. These embodiments require considerations that extend beyond the conventional optimization of normal components of workforce routing.

By way of example, a typical worker's desire may be to end routes near their home, avoid rush hour traffic, and avoid unnecessary zigzagging and backtracking during the work shift. Aesthetically pleasing route shapes can “appear” to be better to a worker's perception than routes based solely on statistical purity or efficiency. Thus, when considering workforce routing, embodiments disclosed herein take technician satisfaction and desires with respect to venturing and homing into consideration.

Accordingly, certain routes may be considered better or worse to a particular technician depending upon the time of day in which a particular job is scheduled relative to the shift of the worker. For instance, a technician's desire to venture relatively long distances may be affected by expected traffic conditions of the roads at different times of the day and by a desire to end the day with a short commute home. Embodiments of workforce routing disclosed herein translates this type of information into useful application for vehicle workforce routing.

Thus, as part of routing a workforce, the needs of the worker are reflected in routes that are created by an algorithm or computer-implemented software. While business objectives may also be taken into account and considered when determining and optimizing routes, the technicians and other field workers desires in driving and working the routes should also provide key criteria for success of the system. Thus, aesthetics and other key factors technicians use when judging satisfaction with their routes are factors considered by the algorithm. Accordingly, embodiments which provide route generation satisfying the needs of technicians without destabilizing stated business objectives are disclosed.

According to one embodiment, the human factors cited above are approximated by a mathematical function that is used to amplify standard values used, for instance, in node or job location selection, such that the goals of the function are reflected as a part of the choices made in route construction. By amplifying, either positively or negatively, the heuristics, such as travel time and skill matches, can be warped to reflect the appeal of jobs to a particular worker at a particular time of day. For instance, the amplification function is itself shaped in a way as to encode a desire to end near the start point, avoid heavy traffic, and discourage backtracking and zigzagging.

By way of example, at the start of the day when traffic may be heaviest, routing technicians to jobs that are relatively nearby may permit productivity to commence immediately without risk of wasted low speed travel time. Further, as busy traffic subsides, venturing further afield may permit longer distances to be covered at higher speeds by technicians and distant jobs to be serviced. Thus, during the middle of the day, more of the distant jobs may be scheduled and serviced, capitalizing on the journey made. In the afternoon, for instance, while traffic may still be relatively light, the worker may again traverse a long distance so that the worker may finish a shift with jobs and assignments located closer to the worker's home.

Accordingly, embodiments disclosed herein use time-bound periodic amplification to model the human instinct for venturing and homing, e.g., to effect the perceived appeal or repulsion of a potential job to a field worker. The ability to incorporate the amplification as a scaled parameter allows blending of weighting into the overall node or job location selection process that occurs within a workforce routing algorithm. For instance, a worker's last job preferably should be near their starting point.

Thus, part of the job selection process disclosed herein involves ranking jobs in terms of desirability from the viewpoint of the technician and a viewpoint that job appeal of the technician may change based upon the predicted location of the worker and the particular time of day. Such analysis may be incorporated into the decision making process of the algorithm that is used to construct a sequence of worker routes.

According to an embodiment, a routing algorithm weighted by business objectives may consider many factors when determining an optimal route for a worker. These different factors can be represented by weighting coefficients. Each coefficient may describe the value of a job to a worker's route and to the operational goals of the business from a different perspective. The combination of the values describes a weight for the job that can be used to rank choices and generate a selection.

Embodiments of one coefficient may be focused on traffic avoidance, guided end location, and an aesthetic route shape, leaving other considerations for other weighting coefficients. The output value may represent the desire for the worker to visit a particular job, assignment, or node at a particular time of day as determined by relevant conditions. By way of example, the output for weighting coefficients may be a quantized value (q) in the following range: 0<q<1. This is consistent with the expectation that the routing algorithm will combine multiple coefficients, each of which may be weighted relative to one another (i.e., each may be weighted similarly, or some may have a greater weight as compared to others).

A wide variety of factors may be considered by an algorithm when choosing which job a worker should next be scheduled to perform. For example, according to some embodiments discussed below, the goal of a so-called venturing or homing function is to appropriately effect decision making responsible for ending a work route close to home. Additionally, this function may model a desire to avoid heavy traffic and to sequence jobs in a manner that avoids regular backtracking or zigzagging.

Thus, as an example, the decision making process may include or consist of the following three driving factors: (i) schedule a few jobs close to home at the start of the day; (ii) schedule venturing out in the morning then back during the afternoon; and (iii) save some jobs close to home for the end of the shift. Of course, this may vary depending upon the times of day or night of a shift. The pattern of scheduling as suggested above should satisfy the needs to avoid rush hour traffic, end close to home, and produce a route without excessive backtracking. Mathematical representation of the changing appeal of particular jobs throughout a working day may be utilized by the algorithm.

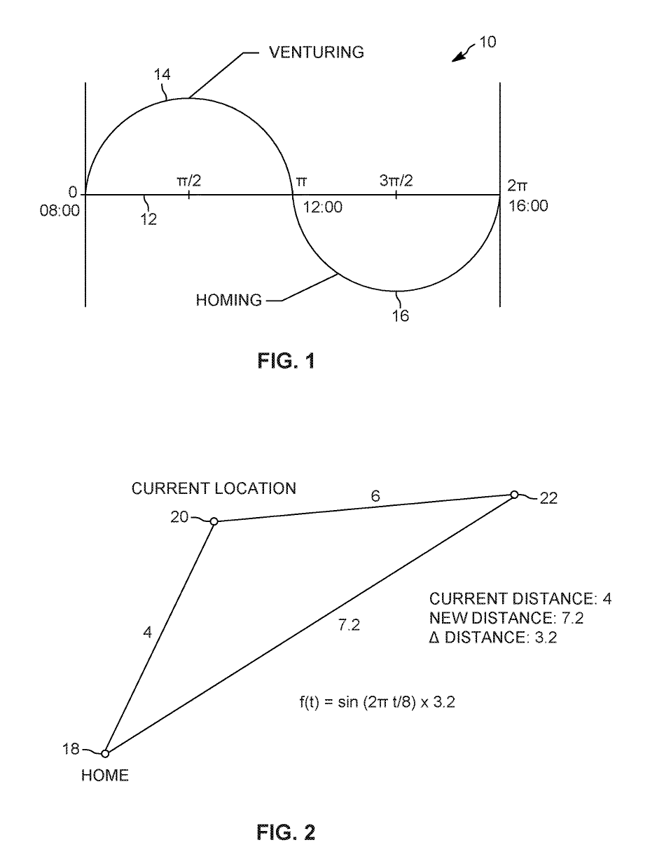

FIG. 1 provides a graph 10 one example of a possible venturing and homing desire for a particular technician through the course of a particular shift of a workday according to an embodiment. In this example, the shift begins at 8:00 (8 AM) and ends at 16:00 (4 PM) as represented on the x-axis 12 of the graph 10. Plotting the above referenced movement between neutral, strong, and weak desires for venturing may produce a graph with a peak 14 in desire for venture at about 10:00 (10 AM) and a trough 16 at about 14:00 (2 PM).

As shown in FIG. 1, this is modeled in the form of a sine function with a peak 14 desire to venture at π/2 (i.e., at 10:00 or LOAM in FIG. 1) and a corresponding trough 16 at π/2 (i.e. at 14:00 or 2 PM in FIG. 1). Thus, such a mathematical function may be used to amplify, either positively or negatively, how much further from home a candidate job would take the worker. The resulting value represents a change in appeal of that job throughout the shift of the working day from the viewpoint of the technician. For example, a job location taking the worker further from home may be more desirable at the peak 14 than the trough 16.

Thus, according to an embodiment, a sine wave, or a series of stepped, angular, undulating, or like segments, may be used to amplify job appeal with a period that generally inclines towards routes exhibiting the appropriate traits. For instance, as best depicted in FIG. 1, a rising period of 0≦x≦π in FIG. 1 which includes peak 14 represents a so-called “venturing” period and the period where π≦x≦2π in FIG. 1 which includes trough 16 represents a so-called “homing” period.

The appeal of each job can be seen as an amplification of the additional distance that job would take the worker from home. By way of example, assuming that “t” represents the hours elapsed in a shift (tracked by a worker during route creation), “d” represents the additional distance of how much further from home a job will take the worker, and “l” represents the full length of a shift (i.e., eight hours in the case of a shift extending from 08:00 to 16:00 as discussed above with respect to FIG. 1), the function “f(t)=sin(2πt/l)” may be used to produce a value for “x” in the range of −1<x<1 representing an appropriate amplification to apply in a workforce routing algorithm. Multiplying by the additional distance (d) produces a value representing the positive or negative appeal of the job at different times of day (i.e., f(t,d)=sin(2πt/l)d).

In the above manner, a job taking a worker a further distance from home may be far more appealing during the middle of the morning in the example illustrated in FIG. 1 (i.e., near peak 14) than during the middle of the afternoon (i.e., near peak 16).

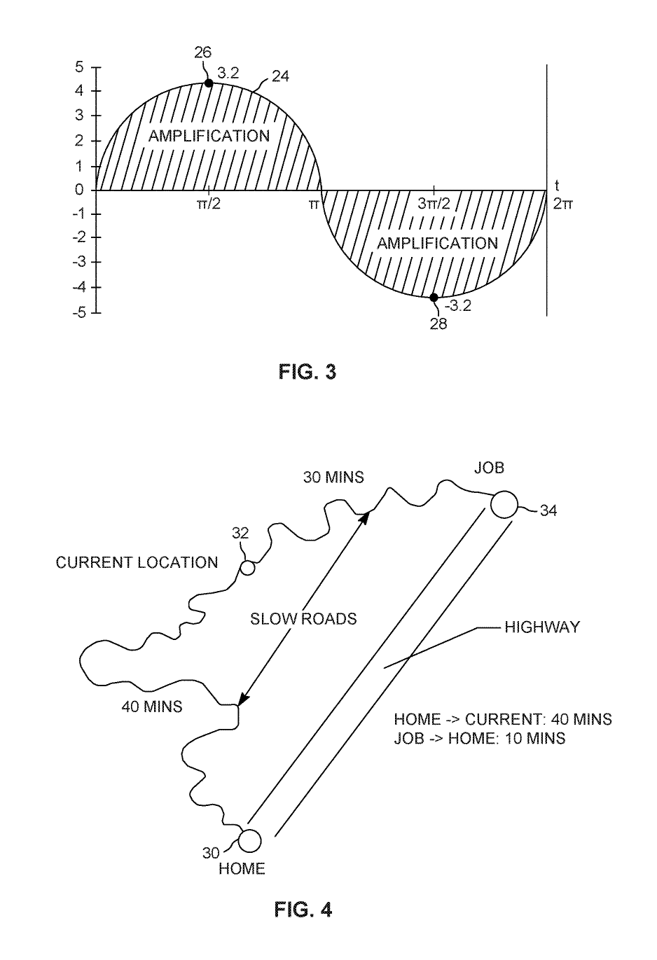

FIGS. 2 and 3 provide a further example of an embodiment. A worker's home or starting point 18 (labeled as “home”), the worker's current location 20 (labeled as “current location”), and a possible next node or job location 22 for the worker to be scheduled are shown in FIG. 2. In this example, the distance from the worker's home 18 to the current location 20 is 4 miles, the distance between the current location 20 and the possible next node or job location 22 to be scheduled is 6 miles, and the distance between the worker's home 18 and the node or job location 22 to be scheduled is 7.2 miles. The function f(t) disclosed above is used with this information to generate the undulating line 24 plotted in FIG. 3. For example: f(t)=sin(2π/8)(7.2−4) for an eight hour shift as in FIG. 1. Thus, the node or job location 22 produces an amplification variance over time as shown by the undulating line 24 in FIG. 3 that is at a greatest value or amplification for venturing (3.2) at a time 26 corresponding to π/2 and at a lowest value for venturing (−3.2) (or a greatest value for homing) at a time 28 corresponding to π/2 on the x-axis

Accordingly, an approximation of the additional distance a job will take a worker from home could be reached by calculating the length of the sides of the triangle formed by the three points as shown in FIG. 2. This quick approximation provides benefits in execution speed; however, it may fail to take into account important information about the physical road conditions connecting the job locations or nodes. For this purpose, the approximation should consider the road network between two nodes or job locations.

For instance, an embodiment may use estimated travel times derived from point-to-point pathfinding algorithms incorporating knowledge of roads, speeds, and traffic restrictions, to determine reasonable costs and time for traversal. In this manner, a job location that appears to be further away from home (in distance or miles in a straight line determination) may actually be closer from a travel time perspective and may be reflected accordingly in the calculated appeal for venturing or homing.

FIG. 4 provides an example of using estimated travel times instead of a straight line path as shown in FIG. 2 for producing a venturing coefficient. For example, the home location 30 appears closer to the worker's current location 32 than a possible next node or job location 34 to be scheduled. However, this may not necessarily be true with respect to actual travel time. As shown in FIG. 4, estimated travel time between the home location 30 and the current location 32 is forty minutes across “slow” roads and estimated travel time between the current location 32 and the next job location 34 to be scheduled is thirty minutes across “slow” roads. In contrast, estimated travel time from the job location 34 to be scheduled and the home location 30 is only ten minutes via highway. Accordingly, instead of or in addition to using straight line miles as used to produce the amplification variance as shown in FIG. 3, the amplification function could use estimated travel time as an alternative or in addition to distance.

With the travel time approximation as suggested above, the final route shape as viewed from a birds-eye view on a map may appear to zigzag and backtrack as points or nodes that appear further away may actually be closer and vice-versa. However, this warped nature of connectivity means the aesthetics of the actual routes when driven by the worker will avoid unnecessary long-haul backtracks despite appearing to do so when viewed in a Cartesian manner. The goal of embodiments disclosed herein is to provide improved driving experiences for field workers.

While the above described embodiments may work well for shifts that are exactly eight hours in length starting and ending at rush hour, the above referenced algorithm may need to be extended for other shift patterns, such as patterns spanning rush hour traffic, while maintaining venturing and homing periods.

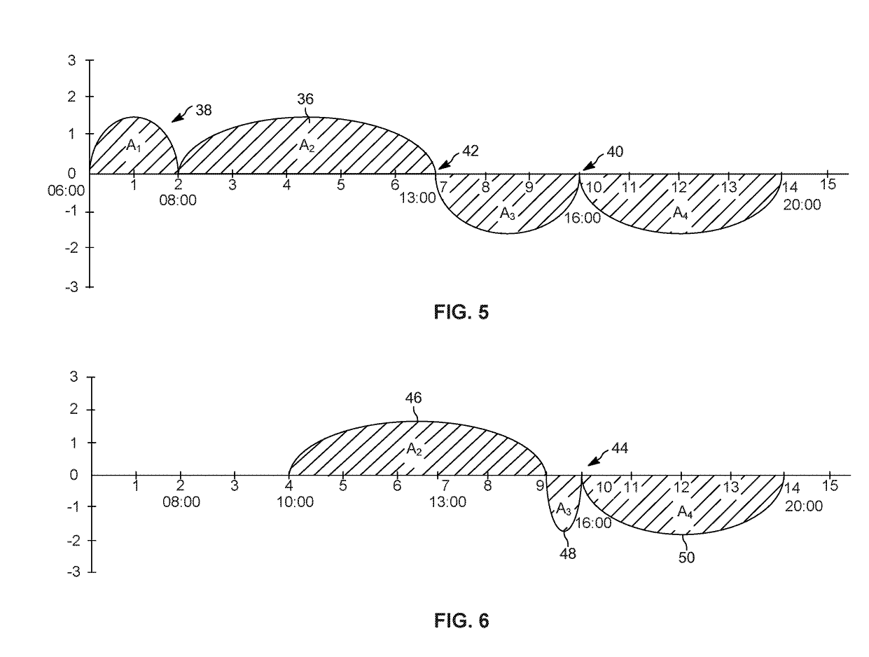

For example, FIG. 5 shows a venturing/homing amplification curve 36 for an extended shift of the worker beginning at 6:00 (6 AM) and ending at 20:00 (8 PM) as indicated on the x-axis representing time of day. This shift spans a morning rush hour 38 (occurring near 8:00 (8 AM)) and an evening rush hour 40 (occurring near 16:00 (4 PM)).

In the embodiment illustrated in FIG. 5, the amplification variance or curve 36 is modified by dipping the venturing or homing appeal at times of busy traffic 38 and 40 (i.e., at 8:00 and 16:00) and resuming the dominant amplification, either venturing or homing, immediately thereafter. There exists a very short period of time during which the appeal is neither positively nor negatively affected, such as during the center of rush hour periods 38 and 40 (i.e., at 8:00 and 16:00 in FIG. 5). The venturing and homing appeals are likely to be weaker closer to the periods of heavy traffic and stronger during periods of quiet traffic.

The amplification at any point in the shift represented by FIG. 5 may be broken into four distinct periods: Venturing 1 (A1 as shown in FIG. 5) which is prior to the first spanned rush hour 38; Venturing 2 (A2 as shown in FIG. 5) which is after the first spanned rush hour 38 and before a mid-point 42 of the shift; Homing 3 (A3 as shown in FIG. 5) which is prior to the second spanned rush hour 40 and after the mid-point 42 of the shift; and Homing 4 (A4 as shown in FIG. 5) which is after the second spanned rush hour 40 and after the mid-point 42 of the shift).

For any venturing area as shown in FIG. 5, the formula for amplification may be as follows: f(t, l)=sin(πt/l), where “t” is time elapsed in current period and “l” is length of current period. Whereas in a homing area, the formula is: f(t, l)=−sin(πt/l), where “t” is time elapsed in current period and “l” is length of current period.

Accordingly, for a shift beginning at 06:00 and ending at 20:00 with rush hour peaks, 38 and 40, identified at 08:00 and 16:00, the periods are: Venturing 1 (A1), 06:00-08:00 (2 hours in length); Venturing 2 (A2), 08:00-13:00 (5 hours in length); Homing 1 (A3), 13:00-16:00 (3 hours in length); and Homing 2 (A4), 16:00-20:00 (4 hours in length). The total shift length is 14 hours, meaning 7 hours are identified for each of venturing and homing. The lengths of the periods A1, A2, A3, and A4 are determined by the rush hour peaks, 38 and 40, and the mid-point 42 of the shift. Therefore, the amplification 36 for each of the periods is calculated using: f_{V1}(t)=sin(πt/2), f_{V1}(t)=sin(πt/5), f_{H1}(t)=−sin(πt/3), and f_{H2}(t)=−sin(πt/4).

The A1 and A4 periods are omitted in the case where either corresponding rush hour 38 or 40 is not spanned. For instance, the same effect is achievable for a shift that spans only a single rush hour period. See FIG. 6 and the rush hour period 44 occurring at 16:00. In this situation there is a single continuous period 46 for venturing but two separate periods, 48 and 50, for homing, since the homing portion of the shift spans the rush hour period 44 but the venturing portion 46 does not.

According to an embodiment, in order for the appeal to be used as a job weighting coefficient in an algorithm, it may be subject to being quantized. For instance, by assuming a maximum radius within which the worker will service jobs, it is possible to measure the appeal relative to the appeal of both best and worst case jobs. This provides a quantized value (q) in the range 0<q<1.

By way of example, assuming that “a” is the amplification (f(t) discussed above), “r” is the maximum travel time from home, “h” is the current travel time from home, “m” is the maximum appeal value (i.e., maximum travel time from home multiplied by the amplification), “n” is the minimum appeal value (i.e., the current travel time from home multiplied by the amplification), and “q” is the quantized appeal, then:

q=((sin(2πt/l)d)+(sin(2πt/l)h))/(sin(2πt/l)r)=(ad+ah)/ar, where a=sin(2πt/l).

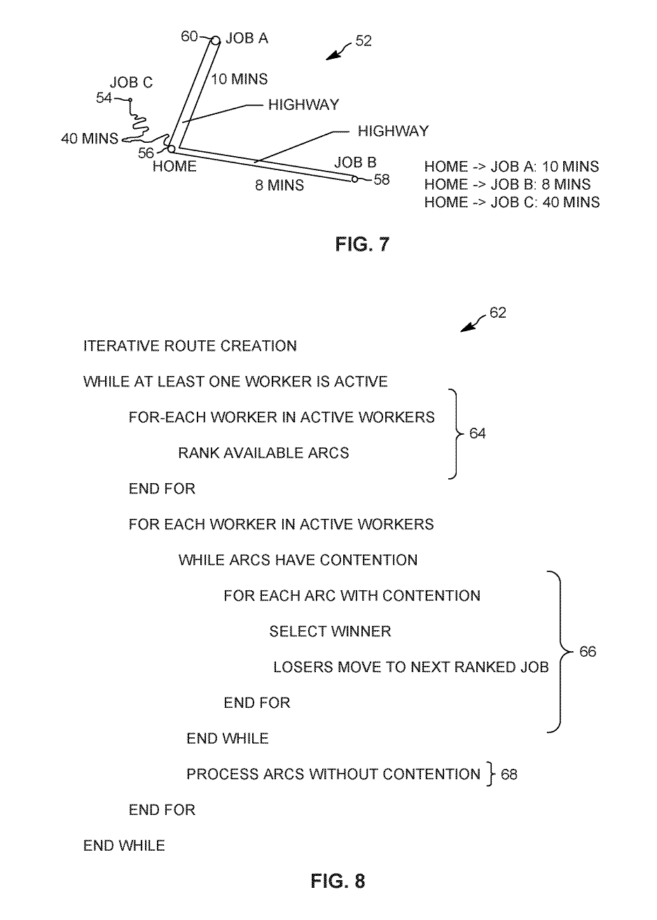

Since circumscribing the working area with a fixed radius may produce an inaccurate representation as could be reached in a few minutes on a highway, but take an hour or more on back roads, as discussed above, the job with the furthest estimated travel time from home (instead of distance) may provide a natural maxima. Thus, job appeal values may be scaled relative to the job causing the worker to be furthest from home from the perspective of estimated travel time, not distance. This may be best exemplified in the map 52 shown in FIG. 7.

In FIG. 7, “Job C” 54 is located closest to “Home” 56 in terms of distance, and “Job B” 58 is located closer to home than “Job A” 60 in terms of distance. However, in terms of expected drive time, it may take the worker forty minutes to reach “Job C” 54 from “Home” 56 using back roads. In contrast, travel time to “Job B” 58 may take only eight minutes by highway and travel time to “Job A” 60 may take only ten minutes by highway.

As discussed above, in workforce management systems responsible for creating worker routes, there exists a need to influence and audit the routes that are created via a set of business objectives. The solutions to vehicle routing optimization problems often involve metaheuristics that are difficult, if not impossible, to both configure and audit in this way. Probabilities lead towards similar solutions on subsequent searches but are not guaranteed and a trade-off is necessary between available execution time and the quality of the solutions that are found. In a deterministic system, the trade-off is a gain in the ability to more tightly configure and audit solutions at the expense of potential optimizations.

With larger numbers of distinguishing traits, more tightly constrained business objectives, and larger pools of workers, a next-best-ranked search can build solutions that satisfy the objectives quickly. Furthermore, the solutions can be audited as the results are entirely deterministic. Accordingly, the use of dynamic temporal weighting components permits choices to be constrained even further and can be encoded to reflect conditions such as traffic, desires to venture and home (as discussed above), system-wide balance, and a need to pair workers with jobs appropriate to their skill levels and inventory.

Route creation may use configurable weighting components to deterministically assign routes to technicians based upon weighted choice mechanics. A model is presented herein of a modular routing service capable of answering questions from perspectives beyond route creation. A deterministic approach is taken with the goal of servicing requests for in-depth analysis behind the choices that are made. Models are described offering previews of how changes in configuration affect potential outcomes.

In an embodiment, the route creation process is iterative. All workers begin at their start locations and receive a single job assignment per iteration until a set of stop conditions are met such as reaching the end of their shift or finding no remaining viable jobs from which to choose. The route creation process ends when all workers have met their stop conditions.

Options are ranked by computing a discrete value for each option and then sorting by that value. The score for each job represents the attractiveness of that job to a specific worker and at a specific point in the route creation process. The value of a job varies due to a variety of dynamic conditions, such as traffic, current workload, the need for breaks, and softer criteria such as the desire for aesthetically pleasing route shapes and a need to finish near a stated home location.

Arcs represent the physical routes between jobs. Each job has many incoming and outgoing arcs. When workers rank their options, they consider factors about both the arcs (travel time, distance, traffic conditions, etc.) and the jobs (skills required, time windows, etc.).

Values from several scoring components are combined into a final composite score for each arc available to a worker. Each component returns a value in the range 0≦s≦1. The individual component weights are scaled using their strengthening coefficients and added together to produce the final score. This may be represented by the formula:

s=Σcw=final arc score
c=strengthening coefficient
w=raw component weighting value

An illustrative example of pseudo-code 62 for a route creation process, according to one embodiment, is provided in FIG. 8. During step 64, for each active worker, each arc, or each job in a set of job locations available to be scheduled, is scored and a ranking of jobs from highest to lowest is generated per worker. Thus, in step 68, if a job is the top ranking for only one worker, then that worker is assigned the job (i.e., the highest ranked job for the specific worker). However, in step 66, for a job that is the top ranked job for multiple of the workers, then a winner and losers are selected. The losers then move to their second ranked job and so forth until all workers are assigned a job. Thereafter, this process repeats until all jobs have been assigned or until all shifts have ended.

As discussed with respect to step 66, a conflict occurs when two or more workers attempt to select the same job. In this case one worker is selected to receive the job while the other workers move to the next selection in their ranked lists. The round ends when all workers have either selected a job or run out of jobs on their list.

When multiple workers have selected the same job, a battle ensues where the relative advantages and drawbacks are compared for each candidate worker and a winner is chosen. A weighting score each worker assigned to the job is used as a basis of how valuable the job is to that particular worker. The worker with the highest weighting for the job in question may be awarded the job.

To avoid a situation where a worker is subject to either a winning or losing streak, workers that lose battles may be awarded points that are used in subsequent conflicts. The points are used to scale the weightings each worker presents when resolving conflict. For example, a worker may lose a point when winning a conflict and may gain a point when losing one. A system-wide constant may specify the amount of scaling each point applies.

### WORKFORCE ROUTING EXAMPLE

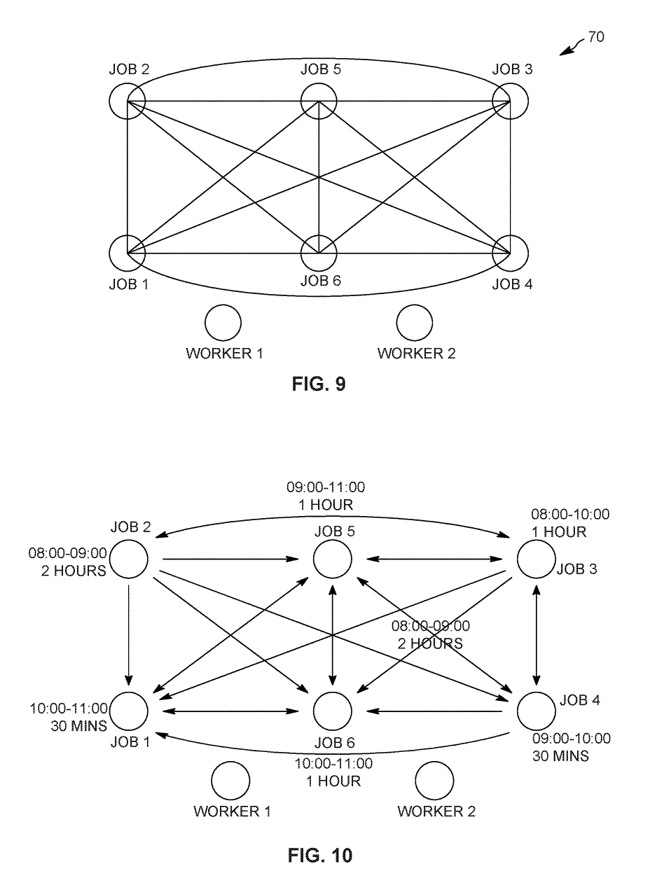

A workforce routing scenario 70 is shown in FIG. 9 which identifies six jobs (Job 1, Job 2, Job 3, Job 4, Job 5, and Job 6) and two workers (Worker 1 and Worker 2). For purposes of starting the routing process, all jobs are connected to all other jobs and all workers are connected to all jobs. For this example, all connections are assumed to be two-way. When time windows are considered as indicated in FIG. 10, several connections can be removed or made one way due to jobs that may start before others are finished. This reduces the number of arcs in the system. Tables 1 and 2 provided below show the set of possible connections. Worker connections are not shown in FIGS. 9 and 10 for clarity.

In this example, it is assumed that both workers can start with any job. As discussed above, there are cases where the end of the time window for the destination job is before the start of the time window for the source job, and thus the arc represents a transition that could never be taken. The various connections may be viewed in the form of a grid as provided in Table 1 (distances) and Table 2 (estimated travel time) which list the distances and estimated travel times for each of the job-to-job connections (i.e., arcs). The ratio of distance to estimated travel time is not always consistent or the same.

TABLE 1

| | | FROM (in miles) | | | | | | | |
|---|---|---|---|---|---|---|---|---|---|
| | | | | | | Job | Job | Worker | Worker |
| DISTANCES | | Job 1 | Job 2 | Job 3 | Job 4 | 5 | 6 | 1 | 2 |
| TO | Job 1 | | 13 | 14 | 17 | 11 | 12 | 6 | 9 |
| (in | Job 2 | | | 20 | | | | 8 | 10 |
| miles) | Job 3 | | 22 | | 8 | 7 | | 12 | 10 |
| | Job 4 | | 14 | 8 | | 9 | 9 | 10 | 8 |
| | Job 5 | 10 | 7 | 4 | 11 | | 13 | 9 | 11 |
| | Job 6 | 8 | 11 | 11 | 9 | 10 | | 7 | 7 |

TABLE 2

| | | FROM (in minutes) | | | | | | | |
|---|---|---|---|---|---|---|---|---|---|
| TRAVEL | | | | | | Job | Job | Worker | Worker |
| TIMES | | Job 1 | Job 2 | Job 3 | Job 4 | 5 | 6 | 1 | 2 |
| TO | Job 1 | | 30 | 28 | 30 | 21 | 18 | 12 | 14 |
| (in | Job 2 | | | 29 | | | | 15 | 21 |
| mins.) | Job 3 | | 32 | | 17 | 21 | | 20 | 19 |
| | Job 4 | | 26 | 17 | | 20 | 24 | 22 | 15 |
| | Job 5 | 20 | 16 | 12 | 26 | | 22 | 17 | 20 |
| | Job 6 | 19 | 24 | 18 | 13 | 18 | | 15 | 12 |

Table 3 lists the skills that are required for each of the jobs. In this example, the jobs relate to a worker of a company providing television, Internet, and telephone services and the jobs do not list the proficiency levels that are required; rather, only workers list proficiency levels with their skills. Business objectives are used to specify what level of proficiency constitutes having a skill The columns in Table 3 listing worker skills reflect the skills which the workers have at the required level of proficiency as indicated, for instance, in a business objective configuration setting.

TABLE 3

| | | | | | | | Worker | Worker |
|---|---|---|---|---|---|---|---|---|
| SKILLS | Job 1 | Job 2 | Job 3 | Job 4 | Job 5 | Job 6 | 1 | 2 |
| Install | X | | X | | X | X | X | |
| Repair | | X | | X | | X | X | X |
| TV | X | X | X | X | X | X | X | X |
| Internet | | X | X | | X | X | | X |
| Telephone | | | | X | X | | X | X |

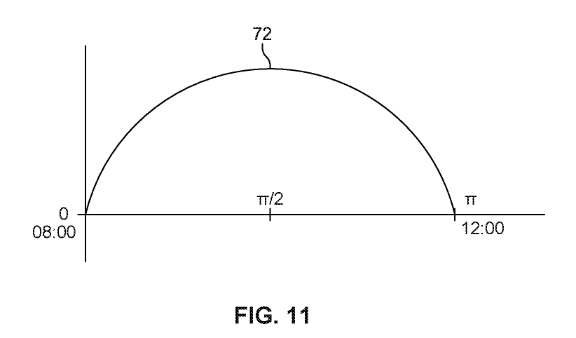

For the purposes of this example it is assumed that both workers have the same 08:00-12:00 shift and that the modeled traffic pattern for this shift period is a sine wave of period 0≦x≦π. For example, see the amplification curve 72 in FIG. 11.

The following description provides a step-by-step walkthrough of the routing process for the six job, two worker scenario described above. Each job selection round is analyzed to provide an insight into the process used to build the resulting routes for the two workers.

First Round of Iterative Route Creation Process

Both workers rank all of the jobs available to them. Below is a detailed analysis of the process by which Worker 1 ranks each of the six jobs. The rankings for Worker 2 are also presented but are not analyzed in the same detail as the same processes can be applied to arrive at the relevant results.

The scores for each component are calculated. The scores are then strengthened by their coefficients. Finally the resulting appeals (score multiplied by strengthening coefficient) are added together to produce a total appeal value or score for each job. Rankings are applied by sorting the jobs by their appeal.

Table 4 shows the weightings for each job for Worker 1 at 08:00. The right-most column of strength shows the strengthening coefficients for each of the components. For each component, both the unmodified score and strengthened appeal values are included. The total appeal and resulting rankings are shown at the bottom of Table 4.

TABLE 4
WORKER 1 ROUND 1 (08:00)

| Weightings | Job 1 | Job 2 | Job 3 | Job 4 | Job 5 | Job 6 | Strength |
|---|---|---|---|---|---|---|---|
| Distance | 6 | 8 | 12 | 10 | 9 | 7 | 1.0 |
| score | 0.2923 | 0.2297 | 0.1221 | 0.1726 | 0.2004 | 0.2604 | |
| appeal | 0.2923 | 0.2297 | 0.1221 | 0.1726 | 0.2004 | 0.2604 | |
| Travel Time | 12 | 15 | 20 | 22 | 17 | 15 | 1.0 |
| score | 0.2222 | 0.1642 | 0.0843 | 0.0590 | 0.1295 | 0.1642 | |
| appeal | 0.2222 | 0.1642 | 0.0843 | 0.0590 | 0.1295 | 0.1642 | |
| Skills | | | | | | | 1.5 |
| score | 1.00 | 0.66 | 0.66 | 1.00 | 0.75 | 0.75 | |
| appeal | 1.5 | 0.99 | 0.99 | 1.5 | 1.125 | 1.125 | |
| Slack Time | 108 | 0 | 0 | 38 | 43 | 105 | 1.0 |
| score | 0.0068 | 1.0000 | 1.0000 | 0.1727 | 0.1371 | 0.0078 | |
| appeal | 0.0068 | 1.0000 | 1.0000 | 0.1727 | 0.1371 | 0.0078 | |
| Time Slot | 0 | 15 | 20 | 0 | 0 | 0 | 2.5 |
| score | 1.000 | 1.000 | 0.7937 | 1.0000 | 1.0000 | 1.0000 | |
| appeal | 2.5 | 2.5 | 1.9842 | 2.5 | 2.5 | 2.5 | |
| Total Appeal | 4.5213 | 4.8839 | 4.1806 | 4.4043 | 4.0920 | 4.0574 | |
| Ranking | 2 | 1 | 4 | 3 | 5 | 6 | |

The skills and timeslot components in this example have been strengthened, meaning that their output values will contribute more strongly to the overall appeal of the jobs considered. For instance, the score for the skills is multiplied by 1.5 and the score for time slot has been multiplied by 2.5.

The following is a walkthrough of the calculations for each of the weighting components to demonstrate how the values for score and appeal are calculated. Only a sample of the calculations for each component is shown for brevity.

The following formulas can be used to calculate the distance component score for each of the jobs considered by Worker 1. The worker's virtual time clock is used to determine how many hours of the current shift period have elapsed.

h=hours elapsed in shift period

p=length of shift period (in hours)

l=longest distance in graph

$$e = sin ( \frac{π h}{p} ) l$$

$$j = \begin{matrix}\text{:} d < e \\ \text{:} d = e \\ \text{:} d > e\end{matrix} \{ \begin{matrix}cos ( \frac{π d}{2 e} ) \\ 0 \\ - sin ( \frac{π ( d - e )}{2 ( l - e )} )\end{matrix} \\ score = \frac{j + 1}{2}$$

Since this is the first selection, the longest distance includes arcs connecting the workers to their first job. The longest arc is between Job 2 and Job 3 at 22 miles, and therefore l equals 22. This is the beginning of the shift so h is 0 and since the shift is from 08:00-12:00, the length of the shift period or p is 4. Thus: h=0; p=4; l=22; and

$$e = sin ( \frac{0 π}{4} ) 22 = 0.$$

Using the formula for j where distance (d) is greater than the estimate (e):

$$j = - sin ( \frac{π ( 6 - 0 )}{2 ( 22 - 0 )} ) = - sin ( \frac{6 π}{44} ) ≅ - 0.4154$$

$$score = \frac{( - 0.4154 + 1 )}{2} ≅ 0.2923$$

This can be observed in the cell in Table 4 showing the distance score for Job 1.

The travel time component is calculated using the same formulae as with the distance component. The value for l is the maximum travel time on any arc rather than the maximum distance. Here: h=0; p=4; l=32; and

$$e = sin ( \frac{0 π}{4} ) 32 = 0.$$

Using the formula for j where distance (d) is greater than the estimate (e):

$$j = - sin ( \frac{π ( 12 - 0 )}{2 ( 32 - 0 )} ) = - sin ( \frac{12 π}{64} ) ≅ - 0.5556$$

$$score = \frac{( - 0.5556 + 1 )}{2} ≅ 0.2222$$

This can be observed in the Table 4 of results for Worker 1 of Round 1.

The skill weighting represents the percentage of the skills required for the job that the worker possesses at the appropriate proficiency level. Looking at Table 5 of required skills it can be seen that there are four jobs for which Worker 1 is missing one skill (i.e., “Internet”).

TABLE 5

| | | | | | | | Worker |
|---|---|---|---|---|---|---|---|
| SKILLS | Job 1 | Job 2 | Job 3 | Job 4 | Job 5 | Job 6 | 1 |
| Install | X | | X | | X | X | X |
| Repair | | X | | X | | X | X |
| TV | X | X | X | X | X | X | X |
| Internet | | X- | X- | | X- | X- | |
| | | missing | missing | | missing | missing | |
| Telephone | | | | X | X | | X |

The above described information leads to the values provided in Table 4 above for the “Skills” row. For instance, for Jobs 2 and 3, Worker 1 has 66% of the required skills, whereas for Jobs 5 and 6, Worker 1 has 75% of the required skills. For Jobs 1 and 4, Worker 1 has all (100%) required skills. In this example, the skill objective scores are strengthened by a factor of 1.5. See Table 4.

Additional factors used to develop an overall score or appeal in the above referenced example are so-called “slack time” and “time slot”. The slack time and time slot scores are calculated using exponential decay with an initial x-offset. In other words, a penalty is assessed for each minute over an acceptable threshold (15 minutes in this example) for each minute over that threshold the worker is expected to arrive. Each additional minute is penalized more heavily than the last. So a worker arriving fifteen minutes late is not penalized at all. A worker arriving twenty minutes late is penalized a small amount, a worker arriving thirty minutes late is penalized a lot more, and a worker arriving sixty minutes late is penalized so heavily as to barely receive any score value from the slack time component at all.

By way of example, Job 1 is scheduled to start at 10:00 (see FIG. 10). Worker 1 has a shift that starts at 8:00 and it is estimated travel time to Job 1 by Worker 1 is twelve minutes. Accordingly, Worker 1 can readily arrive by 10:00 to the job location; thus, the time slot is considered to be 0 minutes corresponding to a full score of 1.0. In contrast, Worker 1 will have a lot of slack time. For instance, Worker 1 may arrive at Job 1 at 8:12. Thus, the slack time before Job 1 is scheduled is 108 minutes. This is considered too high and the corresponding score is very low (i.e., 0.0068). Scores for the other jobs are calculated in a similar manner.

Accordingly, after scores are calculated for each category or factor (distance, travel time, skills, slack time, time slot), they are multiplied by the strength value to produce an appeal value for each category. These values are totaled as shown in the second to last row in Table 4 and rankings are generated from highest to lowest. Thus, for the first round, Job 2 is the highest ranked job for Worker 1. As shown in FIG. 8, step 68, if this is not the highest ranked job for Worker 2, then Worker 1 is assigned Job 2 to begin the shift and Worker 2 is assigned another one of the jobs that is highest ranked for Worker 2. Alternatively, if Job 2 is highest ranked for both Worker 1 and Worker 2, the worker with the highest total appeal value is awarded the job and the other worker is assigned their second ranked job. This iterative process continues for round 2 and round 3 until all six of the jobs are assigned to Worker 1 and Worker 2 or until the end of the shift is reached.

Accordingly, the above Example illustrates a process in which the perspective of the worker traveling the route is considered. The appeal of a job assigned to the worker from a standpoint of an appeal to venture or home is taken into account in the process.

Thus, embodiments disclosed herein disclose a method, such as a computer-implemented method, for generating workforce street level routing. The method be executed on a processor of a computer or like device and include the step of calculating a coefficient representing an appeal for venturing or homing of a specific worker of a workforce at a particular time of day. In addition, for a set of jobs being considered for assignment to the specific worker at the particular time of day, the method includes the step of applying the coefficient in developing scores used to make a job selection for the specific worker at the particular time of day.

The method may include the step of generating a score for each of the set of jobs being considered for assignment to the specific worker at the particular time of day. Each of the scores may be computed from a plurality of factors, and the coefficient representing the appeal for venturing or homing is used to produce at least one of the plurality of factors. The plurality of factors may include at least one of travel distance to a job location and estimated travel time to a job location.

The method may also include the step of ranking the scores for each of the set of jobs being considered for assignment to the specific worker at the particular time of day. In addition, the method may include the step of constructing street level routing including a sequence of jobs assigned to the specific worker in which each of the sequence of jobs corresponds to a highest ranked score for the set of jobs being considered for assignment to the specific worker at each particular time of day during a shift of the specific worker. This may include generating an output providing a schedule including a sequence of jobs assigned to the specific worker.

The appeal for venturing or homing used in the method may be represented by a mathematical function, such as a sine function. The function may produce values corresponding to times of day that the specific worker's appeal is for venturing further from a shift starting or ending location of the specific worker and values corresponding to times of day the specific worker's appeal is for homing closer to the shift starting or ending location of the specific worker. The values for venturing are distinguishable from the values for homing. The mathematical function may include a set of inputs including time elapsed within a shift of the specific worker and a full length of the shift. In addition, the set of inputs may include a value equal to a difference of: i.) a distance from a current location of the specific worker to the shift ending location of the specific worker; and ii.) a distance from a next job location of the specific worker to the shift ending location. The set of inputs may also include a value equal to a difference of: an estimated travel time from a current location of the specific worker to the shift ending location of the specific worker; and ii) an estimated travel time from a next job location of the specific worker to the shift ending location.

Accordingly, the mathematical function may produce values corresponding to an appeal for venturing during a first half of a shift of the specific worker and values corresponding to an appeal for homing during a second half of a shift of the specific worker. In addition, the mathematical function may produce values neutral to the appeals for venturing and homing during anticipated rush hour traffic conditions during the shift of the specific worker.

While the principles of the invention have been described above in connection with specific devices, apparatus, systems, algorithms, and/or methods, it is to be clearly understood that this description is made only by way of example and not as limitation. One of ordinary skill in the art will appreciate that various modifications and changes can be made without departing from the scope of the claims below.

Accordingly, the specification and figures are to be regarded in an illustrative rather than a restrictive sense, and all such modifications are intended to be included within the scope of the present invention.

A system for carrying out the above methods may include software or the like provided on a circuit board or within another electronic device and can include various processors, microprocessors, controllers, chips, disk drives, and the like. It will be apparent to one of ordinary skill in the art that systems, modules, processors, servers, and the like may be implemented as electronic components, software, hardware or a combination of hardware and software for purposes of providing a system.

An embodiment may also include at least one non-transitory computer readable storage medium having computer program instructions stored thereon that, when executed by at least one processor, can cause the at least one processor to perform any of the steps described above.

The word “comprise” or a derivative thereof, when used in a claim, is used in a nonexclusive sense that is not intended to exclude the presence of other elements or steps in a claimed structure or method. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A method for generating workforce street level routing, comprising the steps of:
ranking each job within a set of jobs available for assignment at times of day to a worker of a workforce; and
producing a street level routing assignment schedule including a sequence of jobs assigned to the worker in which each of the sequence of jobs corresponds to a highest ranked job within the set of jobs available for assignment to the worker at each particular time of day during a work-shift;
wherein said ranking step includes creating a coefficient representing an appeal for venturing or homing of the worker at each particular time of day during the work-shift, developing a score from a plurality of factors for each job within the set of jobs at each particular time of day, and using the coefficient representing the appeal for venturing or homing to produce at least one of said plurality of factors; and
wherein the plurality of factors includes at least one of travel distance to a job location and estimated travel time to a job location.

2. The method according to claim 1, wherein said creating step includes representing the appeal for venturing or homing with a mathematical function that produces values corresponding to times of day the appeal of the worker is for venturing further from a shift starting or ending location of the worker and values corresponding to times of day the appeal of the worker is for homing closer to the shift starting or ending location of the worker, and wherein the values for venturing are distinguishable from the values for homing.

3. The method according to claim 2, wherein variables in the mathematical function include time elapsed within a shift of the specific worker and a full length of the shift.

4. The method according to claim 3, wherein the variables include a value equal to a difference of: i.) a distance from a current location of the worker to the shift ending location of the worker; and ii.) a distance from a next job location of the worker to the shift ending location.

5. The method according to claim 3, wherein the variables include a value equal to a difference of: an estimated travel time from a current location of the worker to the shift ending location of the worker; and ii) an estimated travel time from a next job location of the worker to the shift ending location.

6. The method according to claim 2, wherein the mathematical function includes a sine function.

7. The method according to claim 6, wherein the mathematical function includes the following formula: f(t)=sin(2πt/l), where “t” is time elapsed within the work-shift of the worker and “l” is a full length of the shift.

8. The method according to claim 1, wherein at least one of said plurality of factors is computed using the following formula: f(t,d)=(sin(2πt/l))(d), where “t” is time elapsed within a work-shift of the worker, “l” is a full length of the work-shift, and “d” is a difference in at least one of distance and estimated travel time as determined from a current location of the worker to a shift ending location of the worker relative to a next job location of the worker to the shift ending location.

9. The method according to claim 2, wherein the mathematical function produces values corresponding to an appeal for venturing during a first half of the work-shift of the worker and values corresponding to an appeal for homing during a second half of the work-shift of the worker.

10. The method according to claim 2, wherein the mathematical function produces values neutral to the appeals for venturing and homing during anticipated rush hour traffic conditions during the work-shift of the worker.

11. The method according to claim 1, further comprising the step of quantifying the appeal for venturing or homing between minimum and maximum values to produce the coefficient.

12. A system for generating workforce street level routing, comprising:
at least one processor configured to rank each job within a set of jobs available for assignment at times of day to a worker of a workforce, such that said at least one processor is configured to create a coefficient representing an appeal for venturing or homing of the worker at each particular time of day during the work-shift, to develop a score from a plurality of factors for each job within the set of jobs at each particular time of day, and to use the coefficient representing the appeal for venturing or homing to produce at least one of said plurality of factors, wherein the plurality of factors includes at least one of travel distance to a job location and estimated travel time to a job location; and
said at least one processor configured to produce a street level routing assignment schedule including a sequence of jobs assigned to the worker in which each of the sequence of jobs corresponds to a highest ranked job within the set of jobs available for assignment to the worker at each particular time of day during a work-shift.

13. The system according to claim 12, wherein said at least one processor is configured to represent the appeal for venturing or homing with a mathematical function that produces values corresponding to times of day the appeal of the worker is for venturing further from a shift starting or ending location of the worker and values corresponding to times of day the appeal of the worker is for homing closer to the shift starting or ending location of the worker, and wherein the values for venturing are distinguishable from the values for homing.

14. The system according to claim 13, wherein variables in the mathematical function include time elapsed within a shift of the specific worker and a full length of the shift.

15. The system according to claim 14, wherein the variables include a value equal to a difference of: i.) a distance from a current location of the worker to the shift ending location of the worker; and ii.) a distance from a next job location of the worker to the shift ending location.

16. The system according to claim 14, wherein the variables include a value equal to a difference of: an estimated travel time from a current location of the worker to the shift ending location of the worker; and ii) an estimated travel time from a next job location of the worker to the shift ending location.

17. The system according to claim 13, wherein the mathematical function includes a sine function.

18. The system according to claim 13, wherein the mathematical function includes the following formula: f(t)=sin(2πt/l), where “t” is time elapsed within the work-shift of the worker and “l” is a full length of the shift.

19. The system according to claim 12, wherein at least one of said plurality of factors is computed using the following formula: f(t,d)=(sin(2πt/l))(d), where “t” is time elapsed within a work-shift of the worker, “l” is a full length of the work-shift, and “d” is a difference in at least one of distance and estimated travel time as determined from a current location of the worker to a shift ending location of the worker relative to a next job location of the worker to the shift ending location.

20. The system according to claim 13, wherein the mathematical function produces values corresponding to an appeal for venturing during a first half of the work-shift of the worker and values corresponding to an appeal for homing during a second half of the work-shift of the worker.

21. The system according to claim 13, wherein the mathematical function produces values neutral to the appeals for venturing and homing during anticipated rush hour traffic conditions during the work-shift of the worker.

22. A non-transitory computer-readable storage medium comprising stored instructions which, when executed by one or more computer processors, cause the one or more computer processors to perform steps of:
ranking each job within a set of jobs available for assignment at times of day to a worker of a workforce; and
producing a street level routing assignment schedule including a sequence of jobs assigned to the worker in which each of the sequence of jobs corresponds to a highest ranked job within the set of jobs available for assignment to the worker at each particular time of day during a work-shift;
wherein said ranking step includes creating a coefficient representing an appeal for venturing or homing of the worker at each particular time of day during the work-shift, developing a score from a plurality of factors for each job within the set of jobs at each particular time of day, and using the coefficient representing the appeal for venturing or homing to produce at least one of said plurality of factors; and
wherein the plurality of factors includes at least one of travel distance to a job location and estimated travel time to a job location.
